(19) United States
(12) Patent Application Publication
(10) Pub. No.: US 2024/0354485 A1
(43) Pub. Date: Oct. 24, 2024

(54) TRACKING AND/OR PREDICTING SUBSTRATE YIELD DURING FABRICATION

(71) Applicant: Onto Innovation Inc., Wilmington, MA (US)

(72) Inventors: Keith Frank Best, Andover, MA (US); Jian Lu, Chelmsford, MA (US); Prasad Bachiraju, Nashua, NH (US)

(21) Appl. No.: 18/639,045

(22) Filed: Apr. 18, 2024

Related U.S. Application Data
(60) Provisional application No. 63/496,781, filed on Apr. 18, 2023.

(51) Int. Cl. G06F 30/398; G03F 7/00; G03F 9/00; G06F 119/22

(52) U.S. Cl. CPC G06F 30/398; G03F 7/70625; G03F 7/70633; G03F 7/7065; G03F 7/706837; G03F 7/706839; G03F 9/7003; G06F 2119/22

(57) ABSTRACT

Tracking and/or predicting the yield of a semiconductor process. In an embodiment, a tracking method monitors the yield at each layer of the process. This can be used to determine how to proceed. In an embodiment, the prediction method measures the values of at least one attribute of each conductive via on a substrate before the lithography process. The measured values are then compared to predefined values for the same attribute, to determine any deviation. Based on this comparison, an overlay yield of the lithography process is predicted.

### CROSS-REFERENCE TO RELATED APPLICATIONS

This application claims the benefit of and priority to U.S. Provisional Application No. 63/496,781 filed Apr. 18, 2023, the content of which is hereby fully incorporated by reference in its entirety.

### TECHNICAL FIELD

The present disclosure is directed to determining and improving yield of semiconductor substrates.

### BACKGROUND

Advanced packaging (AP) is the aggregation and interconnection of components before traditional electronic packaging. Advanced packaging allows multiple devices (e.g., electrical, mechanical, semiconductor, etc.) to be merged and packaged as a single electronic device, having the effect of reducing a footprint of the chip. Advanced packaging can help achieve performance gains through the integration of several devices in one package and associated efficiency gains (e.g., by enabling electrical signals to move both vertically and horizontally through the devices), as well as enabling high numbers of connections between devices.

Unlike traditional electronic packaging, advanced packaging employs processes and techniques that are performed at semiconductor fabrication facilities. Advanced packaging includes multichip modules, 3D integrated circuits, 2.5D integrated circuits, heterogeneous integration, fan-out wafer-level packaging, system-in-package, quilt packaging, combining logic (processors) and memory in a single package, die stacking several chiplets or dies in a package, combinations of these techniques, and others.

### SUMMARY

One aspect of the present disclosure provides a method for predicting an overlay yield of a semiconductor lithography process, including measuring, before the lithography process, values of at least one attribute of each of a plurality of conductive vias of a semiconductor substrate to provide measured values, comparing the measured values to predefined values for the at least one attribute, and based on the comparing and before the lithography process, predicting an overlay yield of the lithography process to provide a predicted overlay yield.

Another aspect of the present technology provides a method of optimizing a yield of a semiconductor manufacturing process, including: detecting a defect in a first layer of a semiconductor substrate before a second layer of the semiconductor substrate is fabricated to provide a first detected defect; predicting a first yield of the semiconductor substrate based on the first detected defect, including calculating a ratio of a predicted number of a total number of packages of the semiconductor substrate that will be unacceptable due to the first detected defect before fabricating the second layer; determining, based on the first yield, to either: fabricate the second layer of the semiconductor substrate and, thereafter, fabricating the second layer; or scrap the semiconductor substrate without fabricating the second layer.

Another aspect of the present technology provides a method of optimizing a yield of a semiconductor manufacturing process, comprising: detecting a defect in a first layer of a semiconductor substrate before a second layer of the semiconductor substrate is fabricated to provide a first detected defect; and predicting a first yield of the semiconductor substrate based on the first detected defect, wherein the predicting the first yield includes virtually modeling the first layer and one or more additional layers to provide a virtual model of a completed semiconductor substrate, and identifying in the model a second defect in one of the one or more additional layers, the second defect being caused by the first defect.

Another aspect of the present technology provides a method of optimizing a yield of a semiconductor manufacturing process, comprising: inspecting multiple regions of a first layer of a semiconductor substrate before a second layer of the semiconductor substrate is fabricated; detecting, based on the inspecting, a defect in a first region of the multiple regions before the second layer of the semiconductor substrate is fabricated; predicting, based on one or more attributes of the defect, an operational impact of the defect; fabricating a second layer of the semiconductor substrate; and inspecting the second layer for defects without inspecting, based on the operational impact, a region of the second layer corresponding to the first region of the first layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a schematic view depicting an exploded semiconductor substrate fabricated according to an advanced packaging process flow, in accordance with an embodiment of the disclosure.

FIG. 2 is an image depicting an example redistribution layer (“RDL”) bridging defect on a layer of a multilayer semiconductor substrate, in accordance with an embodiment of the disclosure.

FIG. 3 is an image depicting an example defect in the form of a broken RDL conduit line on a layer of a semiconductor substrate, in accordance with an embodiment of the disclosure.

FIG. 4 is an image depicting an example defect in the form of debris partially blocking a via of a semiconductor substrate, in accordance with an embodiment of the disclosure.

FIG. 5 is an image depicting an example of an improperly formed via on a semiconductor substrate, in accordance with an embodiment of the disclosure.

FIG. 6 is an image of an example first layer of a semiconductor substrate including a defect, in accordance with an embodiment of the disclosure.

FIG. 7 is an image of an example second layer of the semiconductor substrate of FIG. 6.

FIG. 8 is an image of an example third layer of the semiconductor substrate of FIG. 7.

FIG. 9 is an image of an example fourth layer of the semiconductor substrate of FIG. 8.

FIG. 10 is a schematic view depicting a translation error in a layer of an example semiconductor substrate, in accordance with an embodiment of the disclosure.

FIG. 11 is a schematic view depicting a rotational error in a layer of an example semiconductor substrate, in accordance with an embodiment of the disclosure.

FIG. 12 is a schematic view depicting a scale error in a layer of an example semiconductor substrate, in accordance with an embodiment of the disclosure.

FIG. 13 is a schematic view depicting an orthogonality error in a layer of an example semiconductor substrate, in accordance with an embodiment of the disclosure.

FIG. 14 is a schematic view depicting a translation error in a layer of an example semiconductor substrate, in accordance with an embodiment of the disclosure.

FIG. 15 is a schematic view depicting a rotational error in a layer of an example semiconductor substrate, in accordance with an embodiment of the disclosure.

FIG. 16 is a schematic view depicting a magnification error in a layer of an example semiconductor substrate, in accordance with an embodiment of the disclosure.

FIG. 17 is a schematic view depicting a system configured to predict a yield of a semiconductor substrate involved in an advanced packaging (AP) process flow, in accordance with an embodiment of the disclosure.

FIG. 18 is a schematic view depicting a neural network configured to identify defects in a semiconductor substrate, in accordance with an embodiment of the disclosure.

FIG. 19 is a schematic view depicting a neuron of the neural network of FIG. 18.

FIG. 20 is a schematic view depicting a system configured to predict a lithography process overlay yield for a semiconductor substrate involved in an AP process flow, in accordance with an embodiment of the disclosure.

FIG. 21 is an organizational view of a predictive lithography process overlay yield solution, in accordance with an embodiment of the disclosure.

FIG. 22 depicts an example graphical output of the predictive multilayered semiconductor substrate yield solution of FIG. 21, in accordance with an embodiment of the disclosure.

FIG. 23 depicts an example graphical output in the form of a heat map of the predictive lithography process overlay yield solution of FIG. 21, in accordance with an embodiment of the disclosure.

FIG. 24 depicts an example graphical output in the form of a histogram of the predictive lithography process overlay yield solution of FIG. 21, in accordance with an embodiment of the disclosure.

FIG. 25 depicts an example graphical output in the form of a vector diagram of the predictive lithography process overlay yield solution of FIG. 21, in accordance with an embodiment of the disclosure.

FIG. 26 depicts an example method of predicting a yield of a semiconductor involved in an AP process flow, in accordance with an embodiment of the disclosure.

FIG. 27 depicts an example method of predicting an overlay yield of a semiconductor lithography process, in accordance with an embodiment of the disclosure.

FIG. 28 schematically depicts an example computer subsystem configured to predict a yield of a semiconductor substrate involved in an advanced packaging (AP) process flow, in accordance with an embodiment of the disclosure.

### DETAILED DESCRIPTION

Advanced packaging processes require high-yield for the many redistribution layers (RDLs) (e.g., conductive traces or interconnects that electrically connect one part of the semiconductor package to another) and layers of vias (e.g., conduits that enable the conduction of electrical signals between layers of a device). This is particularly true for advanced integrated circuit substrates (AICS), which typically include more than ten layers of RDLs and vias per substrate side, each of which must be properly aligned with one another as they are sequentially stacked. As the number of process layers increase, the probability of an alignment error serious enough to cause degraded performance or total package failure also increases. The present disclosure addresses this concern.

Components of an integrated circuit (IC) can be created on a panel/wafer using a lithography process. The lithography process involves repeated exposure (overlaying) of a photoresist layer of the panel/wafer to each of a sequence of patterned photomasks. It is critical that each photomask for each exposure is properly aligned with the panel/wafer for the pattern overlaying to be successful. Otherwise, the IC may function poorly, i.e., have poor “overlay yield.” For example, pattern misalignment of any kind can cause short circuits and connection failures within the IC.

In general terms, the present disclosure relates to improvements in semiconductor panel (or wafer) lithography, and more specifically, to layer-by-layer tracking of semiconductor substrate layer positioning to enhance yield optimization of the substrate, in some cases prior to completion of the fabrication process.

As used herein, a semiconductor wafer is generally a flat discoid object of varying diameter. Semiconductor wafers are generally formed of a semiconductor material such as silicon, gallium arsenide, and the like, though in some instances Glassell composite materials such as epoxy can be used. In some embodiments, the semiconductor wafer can include an orientation structure such as a notch, mark, flat or other structure. Such semiconductor wafers frequently have a diameter of between about 200 mm and about 300 mm, but other sizes of semiconductor wafers are also common.

As used herein, a semiconductor panel is generally a flat object made of semiconductor materials, glass, or composite materials. Semiconductor panels typically have a rectangular or square shape and come in a variety of sizes, although there are common sizes referred to as “generations” with specific dimensions follow: Gen. 1:300×400 mm; Gen. 2:360×465 mm; Gen. 2.5:400×500 mm; Gen. 3:550×650 mm; Gen. 3.5:620×750 mm; Gen. 4:730×920 mm; Gen. 5:1100×1300 mm; Gen. 6:1500×1850 mm; Gen. 7:1870×2200 mm; Gen. 7.5:1950×2200 mm; and Gen. 8:2200×2500 mm. Advanced integrated circuit substrates (AICS) may have the following dimensions: 510×515 mm; or 600×600 mm. In some embodiments, the semiconductor panel can be in the form of a copper core laminate (CCL) panel, etc. In some embodiments, the semiconductor panel can be a glass panel substrate, or other panel constructed of soda-lime glass treated with one or more special coatings to improve the adhesion and uniformity of deposited materials.

As used herein, a semiconductor substrate is a substrate that includes semiconductor material, such as a substrate of a semiconductor panel or a semiconductor wafer. Where some specific information specific to either a wafer or a panel, respectively, is to be related, the specific terms will be used. In some embodiments, either a wafer or a panel can serve as a base upon one or more layers of material are applied and processed to create a multilayered semiconductor substrate. For example, the one or more layers can include one or more redistribution layers, which may include conductive traces, interspaced between insulative, dielectric layers. Through holes can be defined in the wafer or a panel to enable communication between layers applied to opposing major surfaces of the wafer or a panel.

In some embodiments, the semiconductor panel can include an array of repeated functional units, each of which can represent a portion of a semiconducting substrate on which a given functional circuit is fabricated. For example, in one non-limiting example, the functional circuit can take the form of a central processing unit. In some embodiments, additional electrical components can be electrically coupled to the semiconductor panel to complete the functional unit. In other embodiments, the layered semiconductor panel itself can represent a completed functional unit.

Each of the functional units can then be cut from the semiconductor panel into (e.g., rectangularly shaped) dies, wherein each die contains one copy of the functional circuit. To avoid damage to the dies, in some embodiments, a thin, non-functional spacing can be provided between dies, allowing for cutting (e.g., with a saw) of individual dies from a substrate without damaging the circuits. In this manner, a functional circuit can be batch manufactured on a single semiconductor substrate. Once cut into individual dies, the dies can be applied to a printed circuit board for use in electronics.

Advanced integrated circuit substrate process flows often include more than ten layers of RDLs and vias per substrate side, with each subsequent layer relying on the previous layer to serve as its foundation. Accordingly, a defect occurring in one layer may have cascading negative effects in subsequent layers. Typically, the cumulative effects of defects on package yields are not monitored.

Knowing if an advanced integrated circuit substrate has a good package yield at each layer, can increase overall production yields. For example, in one aspect, the disclosed system or method can calculate a percentage yield per layer and display a heat map showing where the defects are occurring per layer, cumulative, per panel, and panel to panel, as well as to provide a user with the ability to set up a minimum yield threshold, enabling production to be ceased at an early processing stage as soon as it is realized that the cumulative package yield is too low to justify further processing.

During semiconductor substrate fabrication, vias are created to allow conductive connection between different substrate layers. The vias can be drilled with a laser through an insulation film of the substrate. Presently, the location and critical dimension (CD) of laser drilled vias is unknown, and depends on a calibration of the laser tool.

By knowing the location and CD of the vias (or a subset of the vias) on the panel/wafer before lithography exposure, the overlay yield can be better predicted across variations in laser calibration. If the predicted overlay yield does not meet a threshold acceptability, the batch can be scrapped before lithography exposure, saving time and resources. If scrapping the batch is not warranted based on the predicted overlay yield, the via location and CD data can also be used to inform and adjust the alignment function, thereby improving the overlay yield.

For example, location and CD of the vias are measured and compared with package dimensions and locations. Based on the comparison, overlay yield can be predicted and one or more actions can be taken, e.g., scrapping the batch, or adjusting the mask alignment.

A typical process flow for fabricating semiconductor devices, such as application specific integrated circuits (ASICS), starts with a pre-processed semiconductor substrate, such as a copper clad laminate. Many layers (e.g., 10 or more) are then added to each side of the laminate. Specifically, the layers are deposited one on top of another to form the semiconductor substrate (e.g., a second layer is deposited and fabricated on a first layer, a third layer is deposited and fabricated on the second layer, etc.). The layers on each side can include, for example in the case of a panel, ten or more redistribution layers (RDL) interspersed with ten or more layers of vias, which can be drilled into layers of insulating film alternating with the RDL. Each panel is divided into packages containing one or more discrete semiconductor devices.

As the fabrication process progresses, defects can occur in different layers in different packages. Such defects can include, for example, RDL bridging, RDL opens, missing vias, and so forth. Thus, the number of defects across the entire semiconductor substrate can increase as more layers are added. In addition, future layers can be impacted by defects occurring in earlier formed layers.

The technology of the present disclosure monitors, or tracks, cumulative defects on a yield, per layer, as the semiconductor substrate is being built. Yield refers to the percentage of packages, devices, dies, etc. of a wafer or panel that will be acceptable. By tracking defects on a per-layer basis, manufacturers can also identify which layers may be more prone to defects, and take steps to improve the process for those layers.

According to another aspect of the present technology, a panel layout design model (e.g., CAD model) is used to look ahead at all future layers not yet fabricated and determine if any such layers will be impacted by defects detected in the current layer. For instance, if a large scratch or deposit is detected to be embedded at Layer 1, it may impact a via at Layer 6 or break a RDL line at Layer 7. Such future impacts can be determined based on the different physical characteristics of the defect in the current layer and its location relative to the RDL pattern. When such future impacts are determined, the user can be automatically alerted to the potential impact of the defect so that the user can decide if the panel should continue processing, or if it is more efficient to scrap the panel before further layers are fabricated.

According to another aspect of the present technology, inspection of subsequent layers can be limited to only those packages (or other functional units) of the panel (or other substrate) in which a fatal defect in a previously fabricated layer has not been detected.

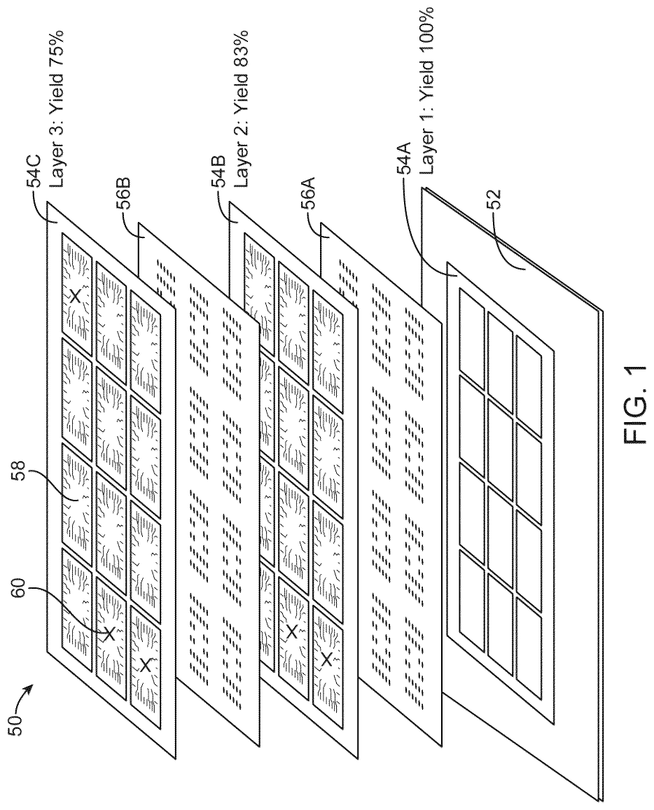

Referring to FIG. 1, a portion of a semiconductor substrate 50 (e.g., an advanced integrated circuit substrate (AICS), etc.) fabricated according to an advanced packaging (AP) process flow, is depicted in accordance with an embodiment of the disclosure. A typical AP process flow begins with a pre-processed substrate 52, such as a panel (e.g., copper core laminate (CCL) panel, etc.) or a wafer (e.g., silica wafer, etc.), upon which multiple redistribution layers (RDLs) 54A, 54B, 54C are interspersed between dielectric layers 56A,56B (e.g., Ajinomoto Build-up Film (ABF), etc.). Although FIG. 1 depicts the semiconductor substrate 50 as including only three RDLs 54A, 54B, 54C, and two dielectric layers 56A, 56B, AICSs often include up to ten to twelve or more RDLs built up on opposing major surfaces of the substrate 52.

The various layers 54A, 54B, 54C, 56A, 56B may be applied to the substrate 52 through a series of fabrication steps. The fabrication steps can include deposition steps where a thin film layer is added onto the substrate 52. The substrate 52, or any layer thereon, can be coated with a photoresist and a circuit pattern of a reticle may be projected onto the substrate 52 using lithography techniques. Etching processes with etching tools can also occur. Vias are typically cut or drilled (e.g., by a laser, etc.) into the dielectric layers 56 to promote electrical communication between the multiple RDLs 54A, 54B, 54C.

Once the RDL 54A, 54B, 54C and dielectric layers 56A, 56B have been applied, the semiconductor substrate 50 is often separated into smaller pieces known as functional units 58 (e.g., packages, devices, dies, etc.), which form the basis of common electronic devices. For the functional units 58 to meet fabrication specifications, each tool involved in the AP process flow must perform within a predefined acceptable operation tolerance for the aspect of the semiconductor substrate for which that tool is responsible.

For example, during the AP process flow, misalignment in lithography processes may occur. These misalignment errors may be essentially random, e.g., the result of environmental factors such as temperature or atmospheric pressure change, or may be the result of systematic factors such as consistent positioning errors associated with semiconductor system errors such as a pick and place system, laser drilling, etching, plating, deposition, ion implantation, etc. These misalignment errors in lithographic processes can cause drops in the yield percentage of a process and can also lead to reduced system throughputs. A yield of 100 percent for the first layer 54A can be calculated by dividing the number of good quality functional units 58 by the total number of functional units 58 (e.g., 12/12×100=100percent). Failure to properly correct for misalignment errors can lead to failed semiconductor substrates, which fail to function properly or lead to premature failure.

In one embodiment, an intelligent, automated way to monitor or track cumulative alignment errors on a semiconductor substrate or yield per layer is disclosed. As the semiconductor substrate 50 is being built, where the yield, defined as the number of good quality functional units 58 (e.g., packages, devices, dies, etc.) coming out of the AP process flow divided by the total number of functional units 58 that undergo the process, directly affects the product output that a manufacturer can expect to obtain. Lower yields or yields that reflect lower product output, or products that may have quality issues that can reduce the amount of revenue one can command for a product

For example, with continued reference to FIG. 1, the semiconductor substrate 50 is shown having three distinct RDLs 54A-C (e.g., a first layer 54A, second layer 54B, and third layer 54C) interspersed between dielectric layers 56A and 56B. Each of the first, second and third layers 54A, 54B, 54C can be divisible into an array of functional units 58 (e.g., packages, devices, dies, etc.). A yield of 100 percent for the first layer 54A can be calculated by dividing the number of good quality functional units 58 by the total number of functional units 58 (e.g., 12/12×100=100 percent).

In the depicted example in FIG. 1, two fatal misalignments e.g., indicated by “Xs” 60 have occurred between the first dielectric layer 56A and the second layer 54B. Based on the AP process flow and the architecture of the semiconductor substrate 50, fatal defects in the functional units 58 of the second layer 54B may cause fatal defects in the functional units 58 of subsequent layers. A yield of 83 percent for the second layer 54B can be calculated by dividing the number of good quality functional units 58 by the total number of functional units 58 (e.g., 10/12×100=83 percent).

As the third layer 54C includes an additional fatal misalignment having occurred between the second dielectric layer 56B, the cumulative yield of 75 percent for the third layer is calculated by dividing the number of good quality functional units 58 by the total number of functional units 58 (e.g., 9/12×100=75 percent). The cumulative yield can be calculated by dividing the total number of good packages in each of the layers by the total number of packages for all of the layers (e.g., 31/36×100=86 percent).

In one embodiment, a user can preset a minimum yield threshold (e.g., 80 percent), such that at any point during the AP process flow if it is determined that enough packages or functional units 58 have fatal defects (e.g., such that the cumulative yield drops below 80 percent), the user can be automatically alerted, and (e.g., at the user's discretion) fabrication can cease and the semiconductor substrate 50 can be scrapped, thereby saving the additional time and resources that would have otherwise been applied to complete an unsatisfactory semiconductor substrate.

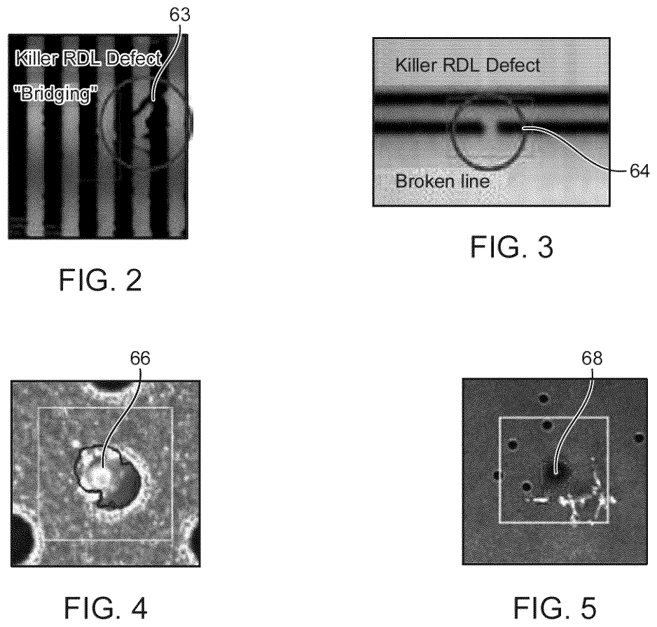

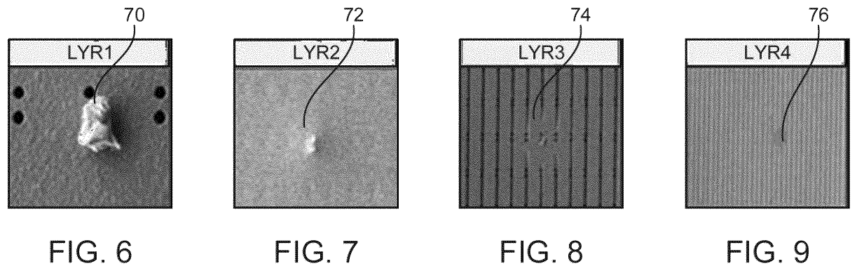

Lithographic processing to create the RDLs 54 can include misalignment errors, as the formed RDLs must be properly oriented with vias defined in the prior dielectric layer 56 in order to function properly. Misalignment errors between drilled vias and subsequent lithographic processes can be exacerbated by improperly formed vias, which can include RDL bridging 63 (as depicted in FIG. 2), RDL opens 64 (as depicted in FIG. 3), laser drilled via residue 66 (as depicted in FIG. 4), incomplete laser drilled vias 68 (as depicted in FIG. 5), fall on a semiconductor substrates (as depicted in FIG. 6), and so forth.

As depicted in FIGS. 6-9, a defect occurring in one layer may have cascading negative effects in subsequent layers. In particular, FIG. 6 depicts a first layer (e.g., Layer 1) including a defect 70. FIG. 7 depicts a second layer (e.g., Layer 2) deposited atop the first layer, in which a portion 72 of the defect 70 is still visible. FIG. 8 depicts a third layer (e.g., Layer 3) deposited atop of the second layer, in which the defect 70 results in RDL opens 74. FIG. 9 depicts a fourth layer (e.g., Layer 4) deposited atop of the third layer, in which a portion of the defect 76 is still faintly visible. Accordingly, depending upon the architecture of the semiconductor substrate 50, a defect 70 discovered early in the AP process flow can propagate into additional defects on subsequent layers, particularly where a subsequent layer includes a critical area (e.g., one or more areas that are critical to operation of the layer or communication between layers)

In some cases, the propagation of defects can result in the completed semiconductor substrate 50 failing to achieve a user defined or desired yield threshold (e.g., a requirement that a given percentage (e.g., at least 80 percent) of functional units will operate at an acceptable level of performance once fabrication of the semiconductor substrate 50 is complete).

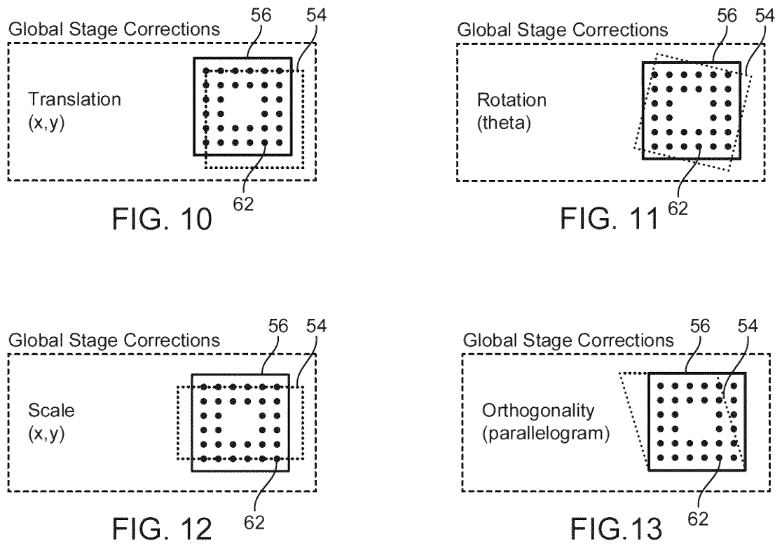

FIGS. 10-16 illustrate non-limiting examples of misalignment in a semiconductor substrate, such as the semiconductor substrate 50 of FIG. 1. Functional unit 58 is representative of a dielectric layer 56 including a plurality of vias 62. Although each of the vias 62 may be formed independently, collectively the vias 62 may form a vias pattern. In practice, the exact position of the vias pattern on the substrate 52 may vary from functional unit 58 to functional unit 58 of FIG. 1. Typically, the position of the vias pattern falls within an established tolerance, such that each of the vias 62 generally align with critical portions of the subsequently applied RDL 54. However, in some cases, the position of the vias pattern may be such that a misalignment between certain vias 62 and the subsequently formed RDL 54 may cause degraded performance in the functional unit 58.

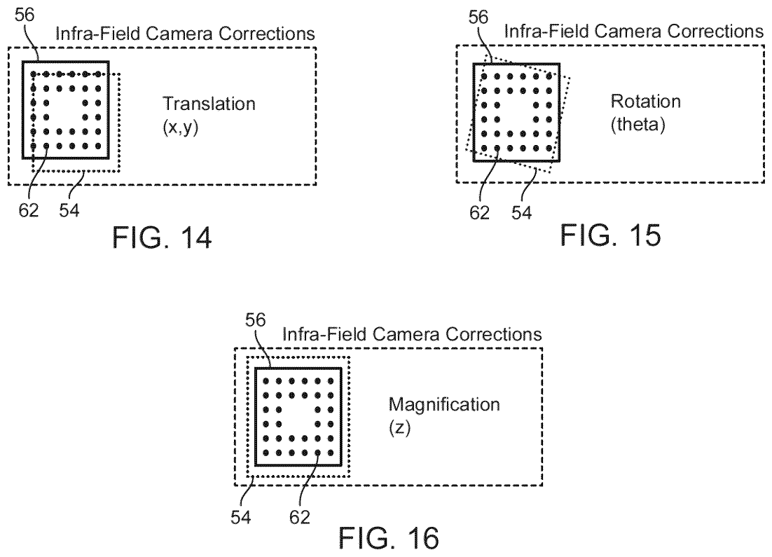

Misalignment errors of the vias 62 can be classified according to global (e.g., linear) errors occurring across multiple functional units 58 positioned within the semiconductor substrate 50, and local (e.g., nonlinear) errors which may be specific to an individual functional unit 58. Global errors can include, for example, translation errors (as depicted in FIG. 10), rotational errors (as depicted in FIG. 11) scale errors (as depicted in FIG. 12), and orthogonality errors (as depicted in FIG. 13). Local errors can include translation errors (as depicted in FIG. 14), rotational errors (as depicted in FIG. 15), and magnification errors (as depicted in FIG. 16). The specific global and local errors discussed herein are listed as examples of common misalignment errors, and should not be considered limiting.

Accordingly, depending upon the architecture of the semiconductor substrate 50, issues with formation of the vias or misalignment of the subsequent lithographic process can propagate into additional defects on subsequent layers, particularly where a subsequent layer includes a critical area (e.g., one or more areas that are critical to operation of the layer or communication between layers). In some cases, the propagation of defects can result in the completed semiconductor substrate 50 failing to achieve a user defined or desired yield threshold (e.g., a requirement that, for a given semiconductor substrate, a given percentage (e.g., at least 80 percent) of functional units 58 will operate at an acceptable level of performance once fabrication of the semiconductor substrate 50 is complete).

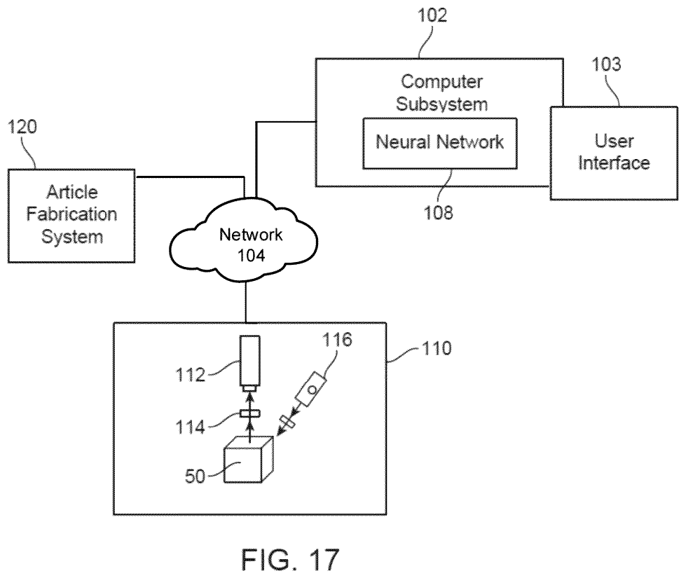

Referring to FIG. 17, a system 100 configured to predict a yield of a semiconductor substrate 50 involved in an AP process flow, is depicted in accordance with an embodiment of the disclosure. The semiconductor substrate 50 can be a completed semiconductor substrate, or a semiconductor substrate that has been only partially fabricated. The semiconductor substrate 50 can be, e.g., a semiconductor substrate of an integrated circuit. In some examples, the semiconductor substrate 50 can include an AICS. In one embodiment, the semiconductor substrate 50 can be fabricated according to an advanced packaging (AP) process flow. In embodiments, the system 100 can include one or more computer subsystems 102 interconnected to a network 104, and loaded with or otherwise configured to execute a neural network 108, as configured and described herein. The network 104, which can be wired or wireless, can serve to connect the one or more computer subsystems 102 with other system components including an article fabrication subsystem 120 and inspection tool 110.

In some embodiments, the system 100 can include an inspection tool 110, which can include a digital imaging subsystem 112, which in some embodiments can include a camera including suitable optics and an imager such as a CCD or CMOS chip. In some embodiments, the digital imaging subsystem 112 can optionally include one or more lenses 114. For example, in some embodiments, the one or more lenses 114 can serve to magnify an image of the semiconductor substrate 50 (e.g., as part of a microscope). Additionally, in some embodiments the lenses 114 can represent one or more filters or polarizers, employed for nuisance suppression to reduce the presence of certain electromagnetic wavelengths generally associated with observable features on a specimen that do not represent defects on the semiconductor substrate 50.

As depicted, the system 100 can further include a light source 116 configured to illuminate the manufactured semiconductor substrate 50. For example, the light source 116 can be a single source, such as a broadband, white light emitting diode (LED) with optical fibers, mirrors, lenses, or filters to direct electromagnetic radiation from the light source 116 as desired, or multiple sources, with each source covering a different part of the electromagnetic spectrum. The light source 116 may include a visible light source such as a broadband LED (e.g., a white light LED) that has an emission spectrum that spans across a range of visible wavelengths. In other cases, the light source can be an incandescent lightbulb, or other filament-based light source. In some embodiments, the light source 116 can be of different illumination types (e.g., incandescent light, fluorescent light, monochromatic laser light, different spectrums of visible light, ultraviolet, x-ray, infrared, etc.).

The digital imaging subsystem 112 can include various types of imaging systems configured to capture different perspectives of the manufactured semiconductor substrate 50. For example, in some embodiments, the digital imaging subsystem 112 can include a camera configured to capture images represented by light across a broad range of the electromagnetic spectrum (e.g., visible light, ultraviolet light, x-ray, infrared light, monochromatic laser light, etc.). In some embodiments, the digital imaging subsystem 112 can comprise a scanning electron microscope, acoustical imaging device, ultrasound imaging device, or the like.

As further depicted in FIG. 17, in some embodiments, the system 100 can incorporate the article fabrication subsystem 120, such that inspection via the inspection tool 110 is seamlessly integrated into the AP process flow, which in some embodiments may include one or more push notifications, alerts or user interface displays presenting a user with an option to address defects discovered by the system 100, for example, via user interface 103. In other embodiments, the system 100 can autonomously make a decision to terminate fabrication of a semiconductor substrate 50, to pause fabrication of the semiconductor substrate 50 for one or more rework processes, or the like.

In some embodiments, images captured by the digital imaging subsystem 112 can be converted, for example via the computer subsystem 102, into a data array of numerical values representing pixels of an image taken of the layer or semiconductor substrate 50, wherein individual elements within the data array can be values representative of the spectral intensity, color, etc. of the individual pixels within a captured image. For example, in one embodiment, images in color having red, green and blue components can be converted to a grayscale, which can then be assigned a numerical value representative of its color or intensity. In some embodiments, the computer subsystem 102 can separate the light into constituent parts using a wavelength specific filter, or one or more sensors using a wavelength specific beam splitter, such that only selected wavelengths are analyzed. In another embodiment, the various components (RGB components, etc.) of a single captured image can be divided, such that each component of the single captured image represents a separate image for input into the neural network 108. In some embodiments, aspects of the lens 114 assembly (e.g., aperture, focal length, etc.) can be adjusted to establish desirable image characteristics.

The data array can then be input into the neural network 108, for example via computer subsystem 102 or components executed by computer subsystem 102, to compute a probability of the presence or absence of a defect (e.g., RDL bridging, RDL opens, laser drilled via residue, incomplete laser drilled vias, fall on a semiconductor substrates, etc.) on the manufactured semiconductor substrate 50. In some embodiments, the output can be in terms of a statistical probability in the form of a percentage or likelihood of the presence of a defect. In other embodiments, the output can be in the form of an image, wherein the image indicates the probability of the presence of a defect on the surface of the manufactured semiconductor substrate 50.

Neural networks typically consist of multiple layers, and the signal path traverses from front to back. The multiple layers perform a number of algorithms or transformations. In general, the number of layers is not significant and is use case dependent. For practical purposes, a suitable range of layers is from two layers to a few tens of layers. Modern neural network projects typically work with a few thousand to a few million neural units and millions of connections. The goal of the neural network is to solve problems in the same way that the human brain would, through the use of specific networked pathways which may resemble networks in the human brain. The neural networks may have any suitable architecture and/or configuration known in the art. In some embodiments, the neural networks may be configured as a deep convolutional neural network (DCNN).

The neural networks described herein belong to a class of computing commonly referred to as machine learning. Machine learning can be generally defined as a type of artificial intelligence (AI) that provides computers with the ability to learn without being explicitly programmed. Machine learning focuses on the development of computer programs that can teach themselves to grow and change when exposed to new data. In other words, machine learning can be defined as the subfield of computer science that “gives computers the ability to learn without being explicitly programmed.” Machine learning explores the study and construction of algorithms that can learn from and make predictions on data-such algorithms overcome following strictly static program instructions by making data driven predictions or decisions, through building a model from sample inputs.

The neural networks described herein may also or alternatively belong to a class of computing commonly referred to as deep learning (DL). Generally speaking, “DL” (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a based model, there are many layers between the input and output, allowing the algorithm to use multiple processing layers, composed of multiple linear and non-linear transformations. DL is part of a broader family of machine learning methods based on learning representations of data. An observation (e.g., an image) can be represented in many ways such as a vector of intensity values per pixel, or in a more abstract way as a set of edges, regions of particular shape, etc.

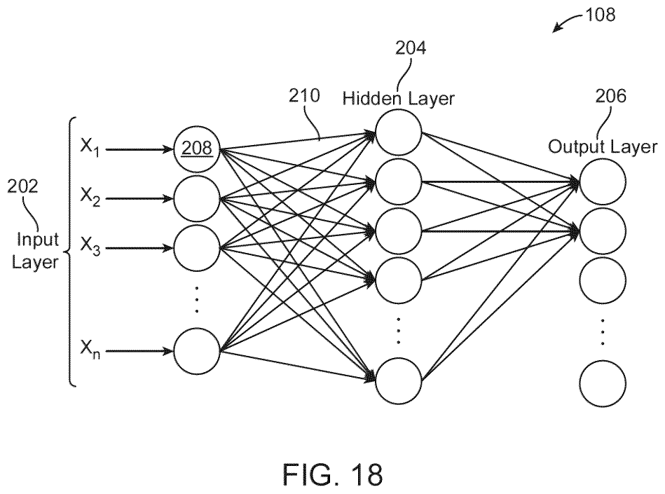

With additional reference to FIG. 18, at a basic level, the neural network 108 can include an input layer 202, one or more hidden layers 204, and output layer 206. Each of the layers 202, 204, 206 can include a corresponding plurality of neurons 208. Although only a single hidden layer 204 is depicted, it is contemplated that the neural network 108 can include as few as one hidden layer or as many hidden layers as desired.

The inputs for the input layer 202 can be any number along a continuous range (e.g., any number between 0 and 255, etc.). For example, in one embodiment, the input layer 202 can include a total of 786,432 neurons corresponding to a 1024×768 pixel output of a digital imaging subsystem 112, wherein each of the input values represents one pixel (e.g., based on a grayscale or RGB color code). In another embodiment, the input layer 202 can include three layers of inputs for each pixel, wherein each of the input values is based on a numerical color code for each of the R, G, and B colors; other quantities of neurons and input values are also contemplated.

Each of the neurons 208 in a given layer (e.g., input layer 202) can be connected to each of the neurons 208 of the subsequent layer (e.g., hidden layer 204) via a connection 210, as such, the layers of the network can be said to be fully connected. Although it is also contemplated that the algorithm can be organized as a convolutional neural network, wherein a distinct group of input layer 202 neurons (e.g., representing a local receptive field of input pixels) can couple to a single neuron in a hidden layer 204 via a shared weighted value. In some embodiments the distinct group of input layer neurons can be selected based on a pixel intensity or other numerical value representing qualities of the pixel.

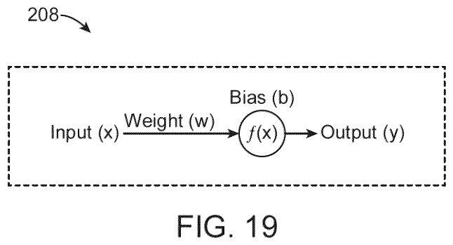

With additional reference to FIG. 19, each of the neurons 208 can be configured to receive one or more input values (x) and compute an output value (y). In fully connected networks, each of the neurons 208 can be assigned a bias value (b), and each of the connections 210 can be assigned a weight value (w). Collectively the weights and biases can be tuned as the neural network 108 learns how to correctly classify detected objects. Each of the neurons 208 can be configured as a mathematical function, such that an output of each neuron 208 is a function of the connection weights of the collective input, and the bias of the neuron 208, according to the following relationship: y=w·x+b.

In some embodiments, output (y) of the neuron 208 can be configured to take on any numerical value (e.g., a value of between 0 and 1, etc.). Further, in some embodiments the output of the neuron 208 can be computed according to one of a linear function, sigmoid function, tanh function, rectified linear unit, or other function configured to generally inhibit saturation (e.g., avoid extreme output values which tend to create instability in the neural network 108).

In some embodiments, the output layer 206 can include neurons 208 corresponding to a desired number of outputs of the neural network 108. For example, in one embodiment, the neural network 108 can include a plurality of output neurons dividing the surface of the manufactured semiconductor substrate 50 into a number of distinct regions in which the likelihood of the presence of a defect can be indicated with an output value. Other quantities of output neurons are also contemplated; for example, the output neurons could correspond to object classifications (e.g., comparison to a database of historical images), in which each output neuron would represent a degree of likeness of the present image to one or more historical images of a known defect.

The goal of the deep learning algorithm is to tune the weights and balances of the neural network 108 until the inputs to the input layer 202 are properly mapped to the desired outputs of the output layer 206, thereby enabling the algorithm to accurately produce outputs (y) for previously unknown inputs (x). For example, if the digital imaging subsystem 112 captures a digital image of a manufactured semiconductor substrate 50 (the pixels of which are fed into the input layer 202), a desired output of the neural network 108 would be the indication of whether further review is desirable. In some embodiments, the neural network 108 can rely on training data (e.g., inputs with known outputs) to properly tune the weights and balances.

In tuning the neural network 108, a cost function (e.g., a quadratic cost function, cross entropy cross function, etc.) can be used to establish how close the actual output data of the output layer 206 corresponds to the known outputs of the training data. Each time the neural network 108 runs through a full training data set can be referred to as one epoch. Progressively, over the course of several epochs, the weights and balances of the neural network 108 can be tuned to iteratively minimize the cost function.

Effective tuning of the neural network 108 can be established by computing a gradient descent of the cost function, with the goal of locating a global minimum in the cost function. In some embodiments, a backpropagation algorithm can be used to compute the gradient descent of the cost function. In particular, the backpropagation algorithm computes the partial derivative of the cost function with respect to any weight (w) or bias (b) in the neural network 108. As a result, the backpropagation algorithm serves as a way of keeping track of small perturbations to the weights and biases as they propagate through the network, reach the output, and affect the cost. In some embodiments, changes to the weights and balances can be limited to a learning rate to prevent overfitting of the neural network 108 (e.g., making changes to the respective weights and biases so large that the cost function overshoots the global minimum). For example, in some embodiments, the learning rate can be set between about 0.03 and about 10. Additionally, in some embodiments, various methods of regularization, such as L1 and L2 regularization, can be employed as an aid in minimizing the cost function.

Accordingly, in some embodiments, the system 100 be configured to utilize pixel data from a digital imaging subsystem 112 as an input for the computer subsystem 102 for operation of a deep learning algorithm for the purpose of automatically assigning a probability that objects viewed by the digital imaging subsystem 112 warrant further review. Although the present disclosure specifically discusses the use of a deep learning algorithm in the form of a neural network 108 to establish the probability of the presence of a defect, other methods of automatic recognition and classification are also contemplated. Moreover, in embodiments, an output from the deep learning algorithm is used by the system to identify defects, which may negatively affect the proper fabrication of subsequent layers, thereby enabling the system 100 to predict yield of a not yet fully fabricated substrate based on the existence of one or more defects in a layer of the substrate that has been fabricated.

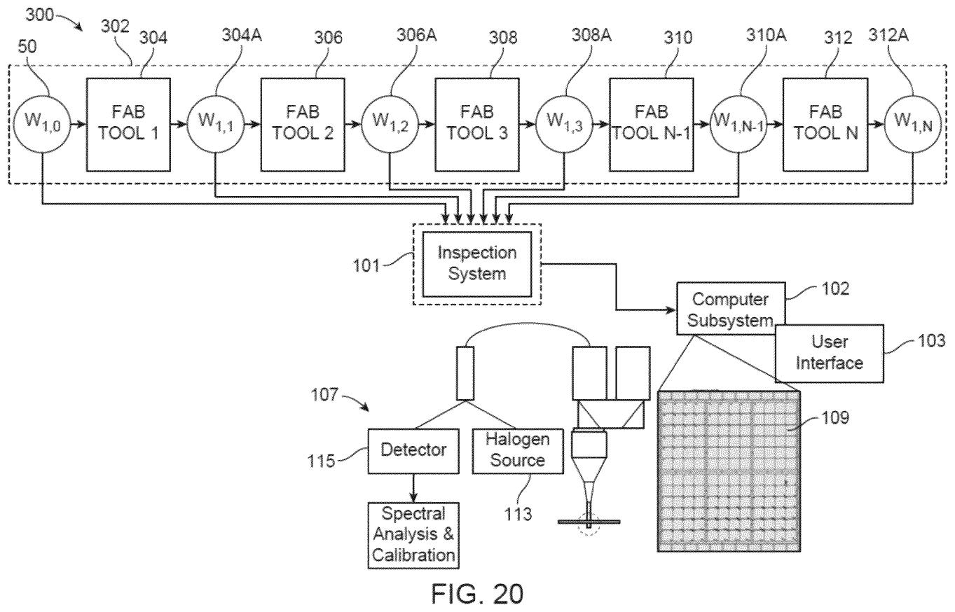

Referring to FIG. 20, a system 300 configured to predict a yield of a semiconductor substrate 50 (such as the semiconductor substrate 50 of FIG. 1) involved in an AP process flow, is depicted in accordance with an embodiment of the disclosure. In some embodiments, the article fabrication system 120 can include multiple fabrication lines 302 for fabricating wafers or other manufactured semiconductor substrates. Each of the fabrication lines 302 can include a plurality of fabrication tools. For example, the fabrication line 302 can include N fabrication tools, such as a first fabrication tool 304, a second fabrication tool 306, a third fabrication tool 308, an N−1 fabrication tool 310, and an Nth fabrication tool 312, where N is an integer greater than 4. The fabrication tools can include various types of fabrication tools used in the wafer fabrication process, such as oxidation systems, epitaxial reactors, diffusion systems, ion implantation equipment, physical vapor deposition systems, chemical vapor deposition systems, lithography equipment, and etching equipment, among other types of tools. While only five fabrication tools are depicted in the fabrication line 302, fewer or more fabrication tools can be utilized. Fewer or more fabrication steps can also be performed, including hundreds of fabrication or processing steps in some examples.

A semiconductor substrate 50 can be fabricated by proceeding through the fabrication line 302 The semiconductor substrate 50 can include a semiconductor substrate, such as a semiconductor substrate of an integrated circuit. In some examples, the semiconductor substrate 50 can include an AICS. In one embodiment, the semiconductor substrate 50 can be fabricated according to an advanced packaging (AP) process flow. Each of the fabrication tools 304, 306, 308, 310, and 312 can perform a process step on the semiconductor substrate 50. In some examples, the semiconductor substrate 50 can be processed by the same fabrication tool more than once. For instance, multiple deposition, lithography, and/or etching steps can be performed on the semiconductor substrate 50. The semiconductor substrate 50 and its respective step can be represented with the following nomenclature: W_{A,B}, where A represents the semiconductor substrate number and B represents the processing stage of the semiconductor substrate. In the example depicted, the semiconductor substrate 50 is represented by W_{1,1} 304A after the first processing step. After the second processing step, the semiconductor substrate can be represented by W_{1,2}, 306A.

After one or more processing steps are performed on the semiconductor substrate 50, the semiconductor substrate 50 can be inspected by an inspection system 101. In embodiments, the inspection system 101 can include one or more computer subsystem 102 and a metrology subsystem 107.

In embodiments, the metrology subsystem 107 can be configured to identify a location of drilled vias and other 3D structures supported by one or more layers defined by the semiconductor substrate 50. For example, in one embodiment, the metrology subsystem 107 can include a laser triangulation sensor configured to gather raw height data including intensity information to estimate a Z-value for a bottom surface of the 3D structure. In some embodiments, the metrology subsystem 107 can include at least one of an interferometer, reflectometer and the like to measure a thickness of the one or more layers. Such metrology subsystem 107 can be beneficially useful in evaluating and measuring one or more dimensions of a three dimensional (3D) structure that is formed in, on or surrounded by a nonmetal layer, such as a dielectric layer 56.

In some embodiments, the metrology subsystem 107 can include a projection unit 113 (e.g., a laser source, halogen source etc.) configured to generate and project a beam of light onto the surface of the semiconductor substrate 50, and a detector, or detection unit 115 capable of receiving or detecting light returned from the surface of the semiconductor substrate 50. In addition to a light source, in some embodiments, the projection unit 113 can include various optical devices or elements (e.g., waveguide, attenuator, etc.). The detection unit 115 can be a camera, such as a CCD or CMOS imaging chip or positioned on sensing device (PSD) arranged at an angle offset to the projection of the axis of the light emitted by the projection unit 113.

Data gathered by the detection unit 115 can be processed by the computer subsystem 102 which can determine an X and Y location, and/or a critical dimension (CD) for each of the vias 62 defined in a layer of the semiconductor substrate 50. In some cases, alignment or dimensions of the vias may affect performance of a previously positioned layer, thereby rendering a portion of the previous layer ineffective. In some embodiments, a yield of the current or previous layer, or cumulative yield of the semiconductor substrate 50 can be computed and provided to a user for a determination of whether a detected position of the vias may cause the current yield to drop below a predefined threshold.

Where the current yield meets desired thresholds, the inspection system 101 can determine whether an alignment of the vias 62 may cause a potential misalignment problem with a subsequently applied lithography process. Where the alignment is correctable, computer subsystem 102 and can apply a stepper match function 109 to provide a calculated alignment for a subsequent lithography process. In embodiments, the stepper match function 109 provides one or more correction factors, which are calculated based on an alignment error, which are in turn used by the system 100 for correcting an alignment error. As depicted in FIG. 20, a stepper match device 109 enables the system 100 to compute and apply correction factors for alignment errors, to ensure alignment for lithography and other processes.

Prior to performing the lithography process under the improved stepper match function, in some embodiments, the inspection system 101 can determine a predicted yield of the layer or cumulative yield of the semiconductor substrate 50 based on at least one of an AP process flow or panel layout CAD (e.g., containing 3D coordinates of the semiconductor substrate layout, or 2D coordinates of each layer, etc.). The computer subsystem 102, or another component of the system 100, can be configured to provide one or more push notifications, alerts or user interface displays presenting a user with an option to address defects discovered by the system 100, for example via user interface 103. In other embodiments, the computer subsystem 102 (or another component of the system 100) can autonomously make a decision to terminate fabrication of a semiconductor substrate 50, to pause fabrication of the semiconductor substrate 50 for one or more rework processes, or the like.

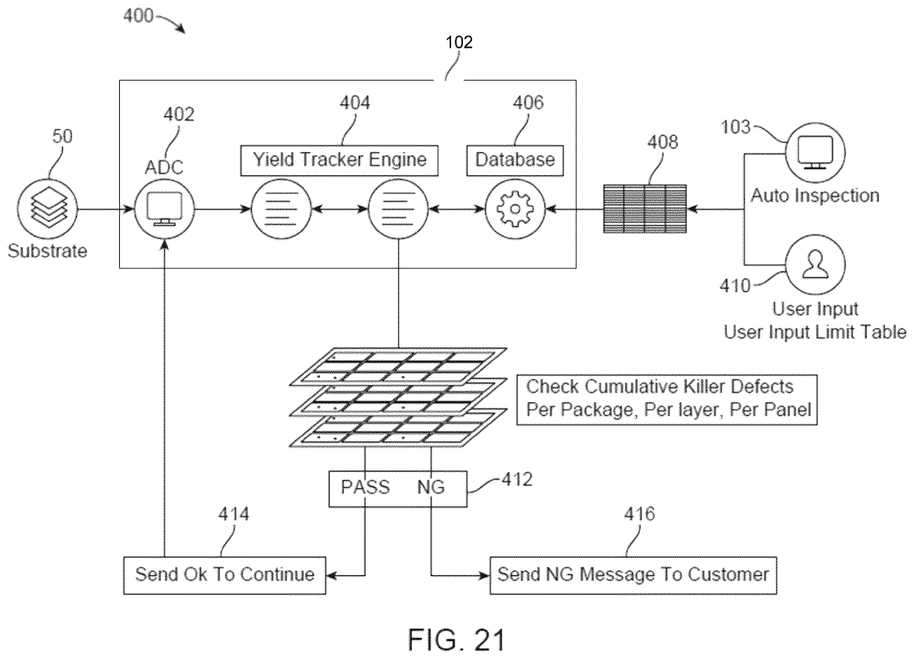

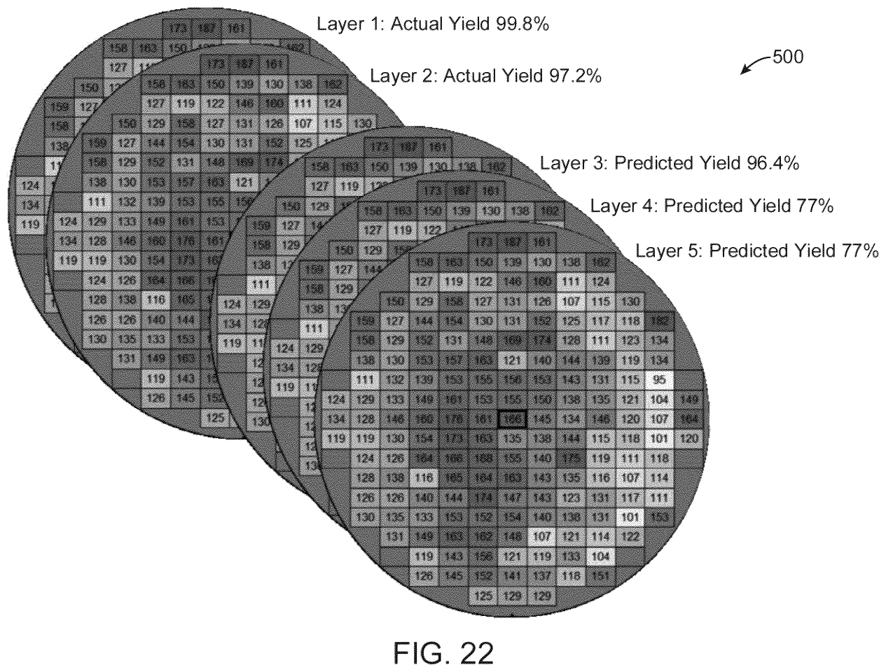

Referring to FIG. 21, an organizational view 400 of yield tracking processes taking place in the computer subsystem 102 is depicted in accordance with an embodiment of the disclosure. In embodiments, the computer subsystem 102 can include an automatic defect classification (ADC) subsystem 402, a yield tracker engine 404, a discover database 406.

In one embodiment, the ADC subsystem 402, can be compiled as an automatic defect classification solution software executed on one or more servers configured to classify defects based on image and metadata such as location, ROI and other information associated with the defect. As described above, ADC classifies defects by first being trained with training data. That is, the ADC subsystem 402 starts by examining samples, extracting and “virtually” memorizing the visual characteristics that separate different types of defects and classes (e.g., tune the weights and biases of the neural network) to later apply that knowledge at run time. Further, in some embodiments, the ADC subsystem 402 can include two or more neural networks, wherein each of the neural networks are independently trained, theoretically arriving at slightly different tuned weights and biases, such that the two or more neural networks can be cross checked against one another to verify results.

In some embodiments, the ADC subsystem 402 can involve a technique for enabling a large process window to detect residue defects on metal and metal defects on organic layers, thereby enabling detection of nonvisible defects. For example, in one embodiment, the ADC subsystem 402 can incorporate highly sensitive camera sensor technology, a dual in-line focus system, and controllable illumination. In some embodiments, the ADC subsystem 402 can include a course z focus system that allows the optics to stay in a desired focal range while a fine focus system continuously measures the local topography as it scans the wafer and adjusts the focus automatically. In some embodiments, the methodology employed by the ADC subsystem 402 rapidly moves the imaging objective and slowly moves the optical head to maintain sharp imagery throughout the inspection. Maintaining focus is particularly important for high-resolution inspection of highly warped semiconductor substrates. In embodiments, the system 100 is capable of capturing organic defects at or below 1 μm.

In some embodiments, the database 406 can be configured to import a list of known defects 408 (e.g., occasionally referred to herein as “killer defects,”) or other defects known or generally considered to be fatal to any given functional unit 58 (e.g., packages, devices, dies, etc.) positioned on any given layer of the semiconductor substrate 50. In embodiments, the known defects 408 can be derived from previous inspection data or input by a user 410. In some embodiments, the known defects 408 can be used as the basis for training data to effectively tune the weights and balances of the neural network 108. In particular, the known defects 408 can be useful in classification of a detected defect into a particular class or category of defect (e.g., type of defect, size of defect, location of defect, etc.), which may have different effects on the yield or predicted yield of the semiconductor substrate 50

For example, one identified defect may be of the type, size or location so as to not cause a cascading effect in subsequent layers. By contrast, another identified defect may be of the type, size or location that suggests that the defect may cause the yield or predicted yield of the semiconductor substrate 50 to fall below a user-defined threshold.

The yield tracker engine 404 can combine defect data from the ADC subsystem 402 and the list of known defects 408 obtained from the database 406, with at least one of an AP process flow recipe or a panel layout CAD (e.g., containing 3D coordinates of the semiconductor substrate layout, or 2D coordinates of each layer, etc.) to look ahead at all layers in the build-up AP process to determine whether future layers will be impacted by one or more defects detected in a current layer. Accordingly, the yield tracker engine 404 correlates defects using automatic defect classification layer to layer as the semiconductor substrate 50 is fabricated. In some embodiments, the defects are tracked to determine the yield loss, which can include a predictive yield loss encompassing layers of the semiconductor substrate 50 that have not yet been completed. In some embodiments, the yield tracker engine 404 can build up a knowledge of correlation between the different attributes and the defects at each layer, as well as a knowledge base for predicting how to know what attribute or defect, what size, what area, shape, position, etc. will negatively affect future layers.

For example, if a defect is identified by the ADC subsystem 402 on Layer 1, the yield tracker engine 404 can communicate with the database 406 to determine the type of defect, as well as potentially other statistical data regarding the type of defect or defects generally. For example, if the defect is identified as a semiconductor substrate having a particular size, then the yield tracker engine 404 can apply one or more rules to predict that the defect will likely cause follow-on defects in functional units 58 positioned at the same x-, y-coordinates in Layer 2, Layer 3, Layer 4, etc. In another example, if it is determined that a scratch is present on Layer 1, the yield tracker engine 404 may determine that the scratch will cause a via to be malformed on Layer 6, and a break in an RDL line to occur on Layer 7.

In some embodiments, these defects can be tracked to determine a yield loss (e.g., defective functional units or packages) during fabrication, and flag a user when the yield drops below a user-defined threshold. At process 412, system 400 can determine if the yield drops below the user-defined threshold. If the yield meets or exceeds the user-defined threshold, the system 100 can deem the semiconductor substrate 50 to have passed inspection, and proceed to process for continued fabrication. Conversely, if the yield fails to meet the user-defined threshold, the system 100 can issue a no go command at process 416, and warn a user of the potential impact of defects, to either automatically or under the guidance of a user either pause or terminate fabrication. Accordingly, the yield tracker engine 404 a user with the ability to scrap a semiconductor substrate 50 early on in fabrication if it is determined that the yield will fall below the defined threshold, thereby inhibiting unnecessary waste and the cost of continued processing until completion.

Further, in some embodiments, the yield tracker engine 404 can provide a user with the ability to visualize defects, not only in the current layers (e.g., Layers 1 and 2), but also in future layers that have not yet been fabricated (e.g., Layers 3, 4 and 5), for example in heat maps or predictions of yield loss per layer. For example, with reference to FIG. 22, a graphical output 500 of the yield tracker engine 404 is depicted in accordance with an embodiment of the disclosure. In some embodiments, the output 500 can provide the user with a series of heat maps identifying the areas or regions including defects by layer. Further, in some embodiments, the output 500 can show a corresponding yield of the semiconductor substrate 50, which can be useful in making a determination of whether or not to cease fabrication and/or send the semiconductor substrate 50 through one or more rework operations to either repair or remove the defect.

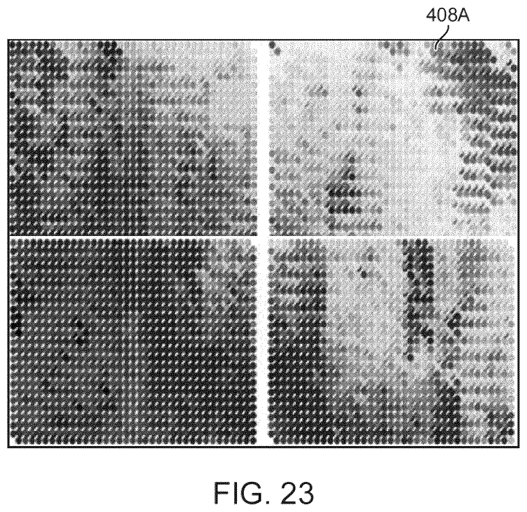

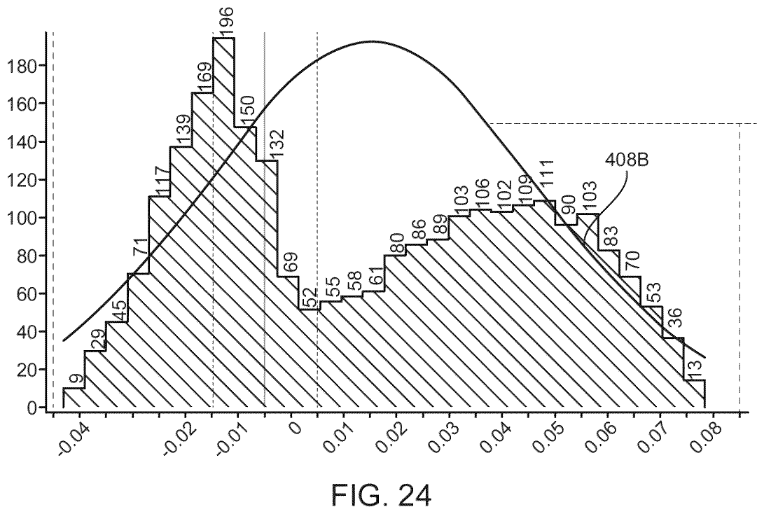

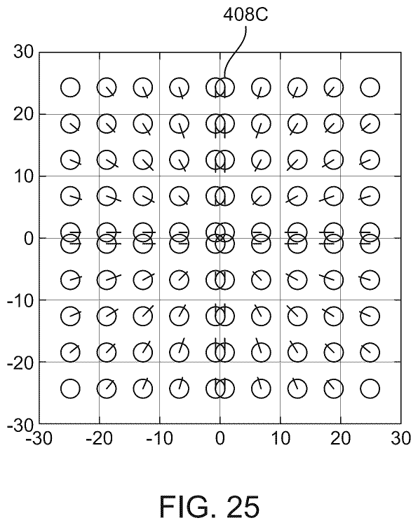

Further, in some embodiments, the system 100 can provide a user with the ability to visualize defects, not only in the current layer, but also in future layers that have not yet been fabricated. For example, with reference to FIGS. 23-25, graphical outputs of the system 100 are depicted in accordance with embodiments of the disclosure. In some embodiments, the output can provide the user with one or more heat maps 408A (as depicted in FIG. 23) identifying the areas or regions including positional error or other identified facts by layer. In some embodiments, the output can be in the form of a histogram 408B (as depicted in FIG. 24) presenting one or more identifiable patterns in the position or critical dimensions of vias in a layer. In some embodiments, the output can be in the form of a vector diagram 408C (as depicted in FIG. 25), which can be useful in visualizing calculated positional corrections to a subsequent lithographic process.

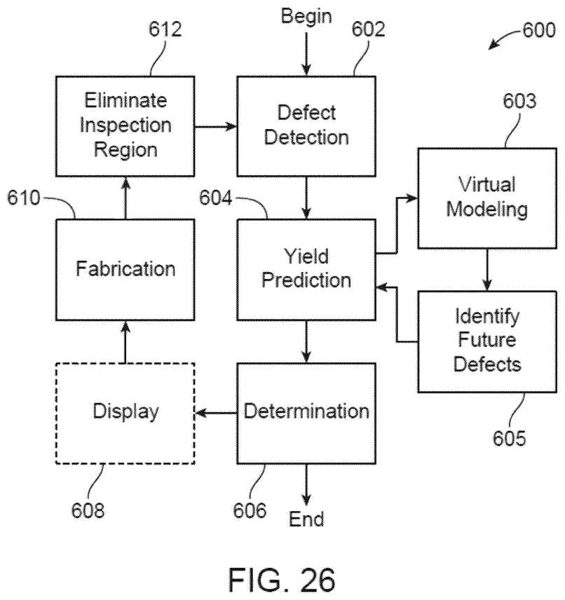

With additional reference to FIG. 26, a method 600 of optimizing a yield in a semiconductor manufacturing process is depicted in accordance with an embodiment of the disclosure. At step 602 of the method 600, the system 100 can be used to gather and process inspection data on an article 50 to identify and optionally classify one or more defects identified on the surface of the article 50. For example, in one embodiment, a region or a subset of the entire surface of the semiconductor substrate can be inspected, thereby enabling the inspection tool 110 to break up the surface of the semiconductor substrate into a series of regions for improved visual acuity dependent upon the specific lens/camera structure of the inspection tool 110, or to save time by eliminating inspection of a region in subsequent layers where a killer defect in a previously fabricated layer (e.g., a defect fatal to a given functional unit 58) was observed. In some embodiments, the region can be a portion of the surface of the article 50 (e.g., a quarter of the surface of the article 50, etc.), which can include multiple functional units 58. In other embodiments, the region can be the area of the article 50 representing a single functional unit 58. In yet other embodiments, the inspection tool 110 can be configured to simultaneously inspect the entire surface of the semiconductor substrate.

In embodiments, defect detection can occur after each layer, and potentially during the fabrication process. For example, the inspection process can occur across multiple regions of a first layer, thereby enabling a defect in the first layer to be identified in a multilayer article before the second layer of the article is fabricated.

At step 604 of the method 600, the system 100 can predict a yield of the article 50 based on the defects detected in step 602. In particular, at step 403, the article 50 can be virtually modeled to represent the various layers of the semiconductor substrate. At step 603 of the method 600, the virtual model can be inspected for defects occurring on future, yet to be constructed layers, thereby enabling the system 100 to predict how a defect on one layer will affect future layers, or performance of the functional unit 58 in which the defect was detected.

At step 606 of the method 600, the system 100 can determine, based on the yield calculated at step 604, whether it is advisable to continue fabrication of the article, or whether the yield of the article 50 has dropped below a user defined yield threshold indicating that continued fabrication of the article 50 is no longer justified.

If it is determined that it is advisable to continue fabrication of the article, the method 600 can advance to step 610, where a subsequent layer of the semiconductor substrate is applied. Where a killer defect was observed (e.g., a defect likely to cause a cascading defects in subsequent layers, which may be fatal to a given functional unit 58), at step 612 of the method 600, the system 100 may omit the region from further inspection. In particular, the system 100 may deem that further inspection of the region is unnecessary, as the region is already known to contain one or more fatal defects. Thereafter, steps 602, 604 and 606 of the method 600 are repeated for the non-eliminated regions.

If during the inspection of a subsequent layer, a defect is identified in a region that had not previously been eliminated, the system 100 can decide to eliminate this additional region from further inspections. For example, if during the inspection of the third layer, a significant defect is identified within a region that was considered non-eliminated based on prior inspections, this region can then be marked for elimination from any further inspection activities for subsequent layers. This action is taken to optimize the inspection process, focusing resources and time on areas of the article 50 that have a higher likelihood of meeting the final product standards. Accordingly, in embodiments, steps 602, 604 and 606 can be repeated for each layer for the non-eliminated regions in a multilayered article 50, with a determination of whether to continue fabrication or cease fabrication performed at each layer.

At the end of the fabrication process, the omitted or eliminated regions are evaluated to determine the impact of the identified defects on the overall functionality and yield of the article 50. If these regions contain functional units 58 that are critical to the device's operation, the entire article may be deemed below the acceptable yield threshold and thus not suitable for its intended application. The advantage of omitting one or more regions from further inspection lies in the significant efficiency gain and resource optimization; by not expending resources on regions already identified as having critical defects, the system can concentrate on inspecting other regions that still have the potential to meet yield thresholds.

In some embodiments, step 608 of the method 600 can be employed to provide a user with a graphical output of the system 100, in which the article 50 is virtually modeled, showing defects or a defect heat map on each of the layers, thereby enabling a user to visualize how a defect on a base layer may affect subsequent layers. In some embodiments, modeling of the graphical output can be representative of an attribute of the defect, including at least one of a type of the defect, a size of the defect, a tool responsible for creating the defect, and a location (e.g., x-, y-coordinates, etc.) of the defect relative to a subsequent RDL or dielectric layer.

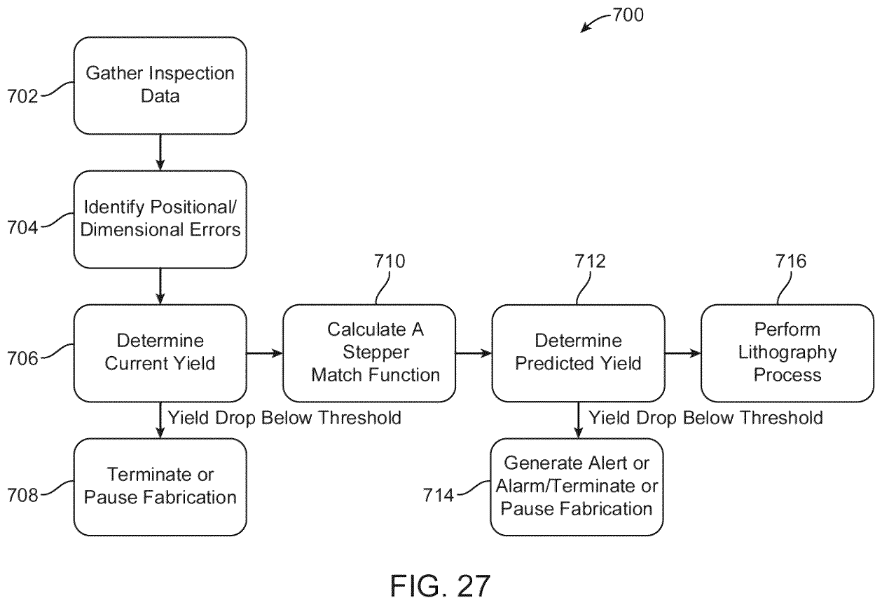

With additional reference to FIG. 27, a method 700 of predicting an overlay yield of a semiconductor lithography process is depicted in accordance with an embodiment of the disclosure. At step 702 of the method 700, the inspection system 101 can be used to gather and process inspection data on a semiconductor substrate to identify at least one attribute for each via 62 defined in a layer of a semiconductor substrate 50. For example, as described above, in one embodiment, the inspection system 101 can employ a laser triangulation sensor configured to use reflected laser light to identify X, Y positional data, CD data, etc. of the vias.

At step 704 of the method 700, the vias attribute data gathered at step 702 can be compared to at least one of a panel CAD layout or AP process flow recipe to identify discrepancies between the actual attribute data and the programmed attribute data. At step 706 of the method 700, a yield of the layer or cumulative yield of the semiconductor substrate 50 can be computed based on any discrepancies identified between the actual vias attribute data and the programmed vias attribute data. At step 708 of the method 700, if the yield falls below a defined threshold, the fabrication process can be terminated and the semiconductor substrate 50 can be scrapped prior to completion of the lithography process.

If the current yield meets production specifications, at step 710 of the method 700, a stepper match function can be performed to determine an ideal positioning of the semiconductor substrate 50 and/or ideal positioning of lithography masking or other aspects of a subsequent lithography process. At step 712 of the method 700, a predicted overlay yield for subsequent layers of the semiconductor substrate 50 can be computed based on the presumption that a subsequent lithography process employing the stepper match function will be applied. At step 714 of the method 700, if the predicted yield falls below a defined threshold, the system 100 can generate an alert or alarm, and/or the fabrication process can be terminated and the semiconductor substrate 50 can be scrapped prior to completion of the lithography process. Conversely, if the predicted yield is deemed acceptable, at step 716 of the method 700 the subsequent lithography process can be completed.

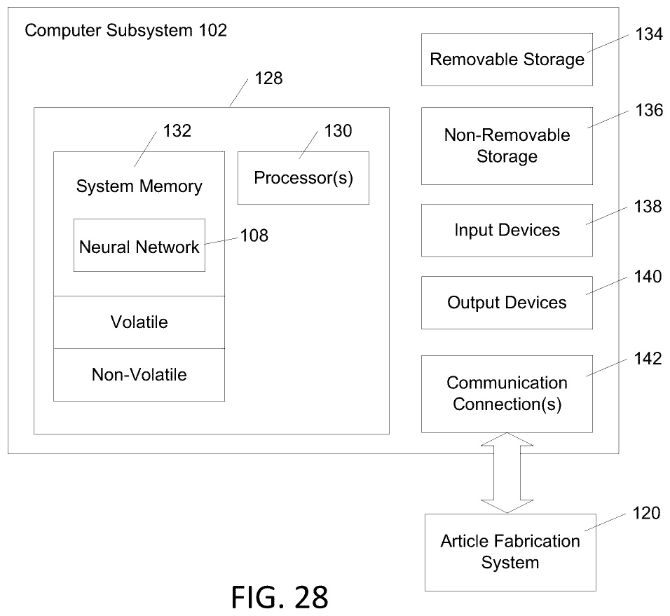

FIG. 28, illustrates an example computer subsystem 102 configured to provide the functionality described herein. In embodiments, the computer subsystem 102 can be a server and/or other computing device that performs the operations discussed herein, such as the classifying defect operations as described herein. The computer subsystem 102 may include computing components 128. The computing components 128 can include at least one processor 130 and memory 132. The memory 132 can include a non-transient computer readable medium. Depending on the exact configuration, memory 132 (storing, among other things, substrate yield prediction instructions and instructions to perform the other operations disclosed herein) can be volatile (such as RAM), non-volatile (such as ROM, flash memory, etc.), or some combination thereof.

Further, the computer subsystem 102 may also include storage devices (removable 134, and/or non-removable 136) including, but not limited to, solid-state devices, magnetic or optical disks, or tape. Further, the computer subsystem 102 may also have input device(s) 138 such as touch screens, keyboard, mouse, pen, voice input, etc., and/or output device(s) 140 such as a display, speakers, printer, etc. One or more communication connections 142, such as local-area network (LAN), wide-area network (WAN), point-to-point, Bluetooth, RF, etc., may also be incorporated into the computer subsystem 102.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

1. A method for predicting an overlay yield of a lithography process, comprising:
measuring, before the lithography process, values of at least one attribute of each of a plurality of conductive vias of a substrate to provide measured values;
comparing the measured values to predefined values for the at least one attribute; and
based on the comparing and before the lithography process, predicting the overlay yield of the lithography process to provide a predicted overlay yield.

2. The method of claim 1, further comprising:
based on the predicted overlay yield, stop performing the lithography process on the substrate.

3. The method of claim 1, further comprising:
based on the comparing, adjusting a mask alignment to provide an adjusted mask alignment; and
performing the lithography process with the adjusted mask alignment.

4. The method of claim 1, further comprising, prior to the measuring:
inspecting the substrate with an imaging device to provide at least one image of the substrate, the at least one image including representations of the plurality of conductive vias,
wherein the measuring is performed using the representations.

5. The method of claim 1, wherein the at least one attribute includes a via location.

6. The method of claim 1, wherein the at least one attribute includes a via critical dimension.

7. The method of claim 3, further comprising predicting a revised overlay yield based on the adjusting.

8. The method of claim 1, further comprising:
predicting a yield of the substrate based on the measured values, including virtually modeling layers of the substrate to provide a virtual model of a completed semiconductor substrate; and
identifying in the virtual model a defect caused by the at least one attribute.

9. A method of optimizing a yield of a semiconductor manufacturing process, comprising:
detecting a defect in a layer of a semiconductor substrate before a next layer of the semiconductor substrate is fabricated to provide a detected defect;
predicting the yield of the semiconductor substrate based on the detected defect, including calculating a ratio of a predicted number of a total number of packages of the semiconductor substrate that will be unacceptable due to the detected defect before fabricating the next layer; and
determining, based on the yield, whether to fabricate the next layer of the semiconductor substrate.

10. The method of claim 9, further comprising:
fabricating the next layer;
detecting another defect in the next layer before a further layer of the semiconductor substrate is fabricated to provide a subsequent detected defect;
predicting a subsequent yield of the semiconductor substrate based on both the detected defect and the subsequent detected defect; and
determining, based on the subsequent yield, whether to fabricate the further layer of the semiconductor substrate.

11. The method of claim 9, wherein the predicting the yield includes:
virtually modeling the layer and one or more additional layers to provide a virtual model of a completed semiconductor substrate; and
identifying in the virtual model a subsequent defect in one of the one or more additional layers, the subsequent defect being caused by the detected defect.

12. The method of claim 11, wherein the modeling and the identifying are based on at least one attribute of the detected defect, the at least one attribute including at least one of a type of the detected defect, a size of the detected defect, a tool responsible for creating the detected defect, and a location of the detected defect relative to a redistribution layer pattern of the semiconductor substrate.

13. The method of claim 9, further comprising applying one or more rules to an attribute of the detected defect in the layer to predict the yield.

14. The method of claim 13, wherein the attribute of the detected defect includes at least one of an x-, y-coordinate of the detected defect, a size of the detected defect, or a classification type of the detected defect.

15. The method of claim 9, further comprising predicting, based on the detected defect, an overlay yield of a lithography process.

16. A method of optimizing a yield of a semiconductor manufacturing process, comprising:
detecting a defect in a layer of a semiconductor substrate before a next layer of the semiconductor substrate is fabricated to provide a detected defect; and
predicting the yield of the semiconductor substrate based on the detected defect, wherein the predicting the yield includes virtually modeling the layer and one or more additional layers to provide a virtual model of a completed semiconductor substrate; and
identifying in the virtual model a subsequent defect in one of the one or more additional layers, the subsequent defect being caused by the detected defect.

17. The method of claim 16, further comprising:
determining, based on the yield, whether to fabricate a subsequent layer of the semiconductor substrate.

18. The method of claim 16, further comprising:
fabricating a subsequent layer;
detecting another defect in the subsequent layer before a further layer of the semiconductor substrate is fabricated to provide a subsequent detected defect;
predicting a subsequent yield of the semiconductor substrate based on both the detected defect and the subsequent detected defect; and
determining, based on the subsequent yield, whether to fabricate the further layer of the semiconductor substrate.

19. The method of claim 18, wherein predicting the subsequent yield includes calculating a ratio of a predicted number of a total number of packages of the semiconductor substrate that will be unacceptable due to the defect and the subsequent defect.

20. The method of claim 16, wherein the virtually modeling and the identifying are based on at least one attribute of the defect, the at least one attribute including at least one of a type of the defect, a size of the defect, a tool responsible for creating the defect, and a location of the defect relative to a redistribution layer pattern of the semiconductor substrate.

21. The method of claim 16, further comprising predicting, based on the detected defect, an overlay yield of a lithography process.

22. A method of optimizing a yield of a semiconductor manufacturing process, comprising:
inspecting multiple regions of a layer of a semiconductor substrate before a subsequent layer of the semiconductor substrate is fabricated;
detecting, based on the inspecting, a defect in one region of the multiple regions before the subsequent layer of the semiconductor substrate is fabricated;
predicting, based on one or more attributes of the defect, an operational impact of the defect;
fabricating the subsequent layer of the semiconductor substrate; and
inspecting the subsequent layer for defects without inspecting, based on the operational impact, a region of the subsequent layer corresponding to the one region of the layer.

23. The method of claim 22, wherein the operational impact includes an overlay yield of a lithography process.
